(19) United States
(12) Patent Application Publication
(10) Pub. No.: US 2011/0303037 A1
(43) Pub. Date: Dec. 15, 2011

(54) DRIVE UNIT OF A TRANSMISSION

(75) Inventors: Holger DOLESCHAL, Wiesbaden (DE); Andreas BARYLLA, Gernsheim (DE); Wolfgang BOHRMANN, Wiesbaden (DE)

(73) Assignee: GM GLOBAL TECHNOLOGY OPERATIONS LLC, Detroit, MI (US)

(21) Appl. No.: 13/020,151

(22) Filed: Feb. 3, 2011

(30) Foreign Application Priority Data
Feb. 3, 2010 (DE) 102010006644.3

(51) Int. Cl. F16H 57/04

(52) U.S. Cl. 74/467

(57) ABSTRACT

A drive unit of a transmission is provided that includes, but is not limited to a main shaft. The main shaft includes, but is not limited to a bore formed along its centre axis for the transport of lubricating oil. The lubricating oil can be introduced into the bore via a feed line, and a sealing element is provided in a transition region between the bore and the feed line.

### CROSS-REFERENCE TO RELATED APPLICATION

This application claims priority to German Patent Application No. 102010006644.3, filed Feb. 3, 2010, which is incorporated herein by reference in its entirety.

### TECHNICAL FIELD

The technical field relates to a drive unit of a transmission with a main shaft.

### BACKGROUND

The main shaft of a transmission usually comprises a bore formed along its centre axis, via which from a differential gear lubricating oil can be brought into needle bearings of the drive organs and the synchronizers arranged on the main shaft. Bringing the lubricating oil into the bore is usually effected via a feed line which leads from the differential gear as far as into the bore. Here, there is often the problem that not all the lubricating oil brought into the bore can be utilized for lubricating the needle bearings, since some of the lubricating oil is able to flow back again into the differential gear or into the region of the differential gear through a gap between the bore and the feed line. Because of this, the lubrication of the needle bearings and thus also the efficiency of the transmission is reduced.

It is therefore at least one object to make available a drive unit of a transmission where the rate of loss of the lubricating oil introduced into the bore of the main shaft can be reduced. In addition, other objects, desirable features and characteristics will become apparent from the subsequent summary and detailed description, and the appended claims, taken in conjunction with the accompanying drawings and this background.

### SUMMARY

The drive unit of a transmission according to an embodiment comprises a main shaft. The main shaft comprises a bore for the transport of lubricating oil formed along its centre axis. The lubricating oil can be introduced into the bore via a feed line. In a transition region between the bore and the feed line a sealing element is provided.

Here, the transition region is the region where the feed line merges into the bore. Through the provision of a sealing element in the transition region between the bore in the main shaft and the feed line led out of the differential gear the loss of lubricating oil at the transition from the feed line into the bore can be reduced. In particular, flowing back of the lubricating oil into the differential gear via a gap, which is usually provided in the transition region between the bore and the feed line, can take place because of this. The sealing element serves to seal this gap between the bore and the feed line. Because of this, the quantity of the lubricating oil transported to the needle bearings via the bore can be increased, as a result of which the efficiency of the entire drive unit can be increased. On the one hand, the sealing element serves to prevent that the lubricating oil unintentionally re-emerges from the bore. The lubrication of the needle bearings can be substantially increased because of this. The loss of lubricating oil in the transition region between the bore and the feed line can be reduced towards 0 by means of the sealing element. Because of this, the entire lubricating oil transported in the bore can be utilized for lubricating the needle bearings. Because of this, damages to the needle bearings can be reduced on the basis that now a larger and accurately determinable quantity of lubricating oil is available. Because of this, the roller bearings provided on the transmission housing can likewise be adequately supplied with lubricating oil via the bore. To this end an additional oil transport line is then preferentially provided from the bore to the roller bearings.

According to another embodiment, the feed line comprises an insertion region partially inserted in the bore. The sealing element is arranged in the insertion region between the outer circumferential surface of the feed line and the inner circumferential surface of the bore. In the insertion region, preferentially the feed line has a smaller diameter than the bore, so that the feed line in this region can protrude into the bore. In that the sealing element is arranged in the insertion region between the outer circumferential surface of the feed line and the inner circumferential surface of the bore the gap between the bore and the feed line can be particularly effectively sealed off. The sealing-off element in this case is arranged radially to the centre axis of the bore or to the centre axis of the feed line on the outer circumferential surface of the feed line and/or the inner circumferential surface of the bore.

In addition it is preferably provided that the sealing element is fastened to the inner circumferential surface of the bore. When assembling the feed line to the bore the feed line can be pushed into the sealing element already fastened to the inner circumferential surface of the bore, wherein because of the rotary movement of the main shaft together with the sealing element fastened thereto and the feed line which is fixed in contrast thereto, preferentially a small gap between the sealing element and the outer circumferential surface of the feed line is provided. Through the possibility of pushing the feed line into the sealing element fastened in the bore a particularly simple assembly of the feed line in the bore is made possible.

The sealing element is preferentially designed as sealing ring. The sealing ring can for example be designed as a shaft-sealing ring. By providing a sealing ring as sealing element, no additional design effort or change of the bore or the feed line is necessary in order to fasten the sealing element to the main shaft or to the feed line. Possibly it can be provided here that on the bore in the region of the transition region a clearance is provided, in which the sealing element designed as sealing ring can be inserted.

In addition it is preferably provided that the sealing element is injection molded onto the outer circumferential surface of the feed line. Before the assembly of the feed line in the bore the sealing element in this case can be injection molded onto the outer circumferential surface of the feed line so that upon fastening of the feed line in the bore the feed line can be pushed into the bore together with the sealing element. In that the sealing element is injection molded onto the feed line the sealing element is arranged in a fixed position and cannot slip upon assembly with the bore. Because of this, a secure and specific assembly of the feed line to the bore can be performed. Here, a plastic material, more preferably an elastomer, for example in form of a rubber, is preferentially injection molded onto the outer circumferential surface of the feed line For example the sealing element in the process can surround the outer circumferential surface of the feed line in the shape of a ring.

In addition, it is preferably provided alternatively that the sealing element is designed in the form of a bushing. The bushing in this case can be provided as intermediate element between the feed line and the bore. By providing a bushing as sealing element a particularly simple manufacture and assembly is possible, while the bush for example can also be of a split design in order to make possible a particularly simple assembly on the feed line or in the bore.

According to another embodiment, the sealing element designed as bushing is pressed into the inner circumferential surface of the bore. Because of this, the sealing element designed as bushing co-rotates upon a rotary movement of the main shaft. The feed line joined into the sealing element is preferentially arranged in such a manner that between the outer circumferential surface of the feed line and the sealing element a small gap is provided, so that no friction between the outer circumferential surface of the fixed feed line and the circulating sealing element develops. Here, the bushing can for example be formed of an elastomer.

In addition, a transmission is provided comprising a drive unit embodied and further developed as above.

### BRIEF DESCRIPTION OF THE DRAWINGS

The embodiments will hereinafter be described in conjunction with the following drawing figures, wherein like numerals denote like elements, and:

FIG. 1 a schematic representation of the drive unit according to a first embodiment;

FIG. 2 a schematic representation of the drive unit according a second embodiment; and

FIG. 3 a schematic representation of the drive unit according to a third embodiment.

### DETAILED DESCRIPTION

The following detailed description is merely exemplary in nature and is not intended to limit application and uses. Furthermore, there is no intention to be bound by any theory presented in the preceding background or summary or the following detailed description.

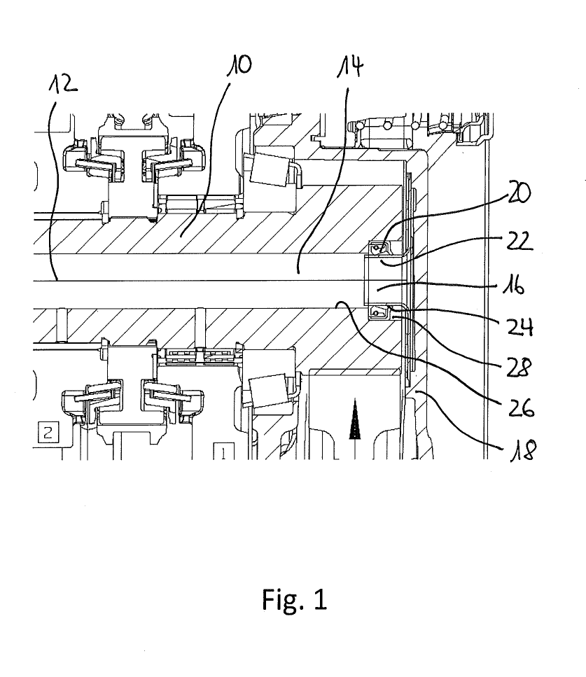

FIG. 1 shows a schematic representation of a first embodiment of a drive unit of a transmission with a main shaft 10. The main shaft 10 comprises a bore for the transport of lubricating oil formed along its centre axis 12. The lubricating oil can be introduced into the bore 14 via a feed line 16, which is connected to a differential gear 18. In the transition region between the bore 14 and the feed line 16, as shown in FIG. 1, a sealing element 20 is provided. The sealing element 20 in this case is designed in the form of a sealing ring, for example in the form of a shaft-sealing ring. The feed line 16 in the transition region has a smaller diameter than the inner diameter of the bore 14, so that the feed line 16 has an insertion region 22 partially inserted into the bore 14. The sealing element 20 in this case is arranged in the insertion region 22 between the outer circumferential surface 24 of the feed line 16 and the inner circumferential surface 26 of the bore 14. In the insertion region 22 the bore 14 has an additional clearance 28, in which the sealing element 20 is arranged.

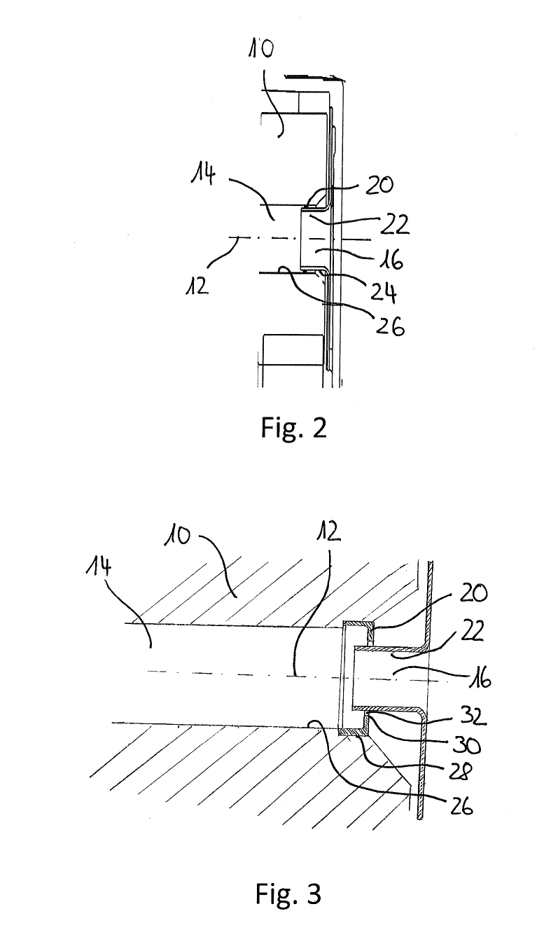

FIG. 2 shows a second embodiment of the drive unit. In this case the sealing element 20 is injection molded onto the outer circumferential surface 24 of the feed line 16. The sealing element 20 in this case is arranged in the form of an elastic ring on the outer circumferential surface 24 of the feed line 16 and borders on the inner circumferential surface 26 of the bore 14. Because of the elasticity of the sealing element 20 the latter upon a revolution of the main shaft 10 can be guided along the inner circumferential surface 26 of the bore 14.

FIG. 3 shows a third embodiment of the drive unit. In this case the sealing element 20 is designed as bushing. The sealing element 20 designed as bushing is fastened to the inner circumferential surface 26 of the bore 14, preferentially pressed into a clearance 28 in the main shaft 10. The sealing element 20 designed as bushing preferentially comprises an opening 30, through which the insertion region 22 of the feed line 16 is guided. between the outer circumferential surface 24 of the feed line 16 and the sealing element 20 a small gap 32 is provided, as a result of which a friction between the sealing element 20 rotating with the main shaft 10 and the feed line 16 can be prevented.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A drive unit of a transmission, comprising:
a main shaft comprising a bore) for transport of a lubricating oil formed along a centre axis;
a feed line adapted to introduce the lubricating oil into the bore; and
a sealing element in a transition region between the bore and the feed line.

2. The drive unit according to claim 1,
wherein the feed line comprises an insertion region partially inserted into the bore, and
wherein the sealing element is arranged in the insertion region between an outer circumferential surface of the feed line and an inner circumferential surface of the bore.

3. The drive unit according to claim 2, wherein the sealing element is fastened to the inner circumferential surface of the bore.

4. The drive unit according to claim 1, wherein the sealing element is a sealing ring.

5. The drive unit according to claim 2, wherein the sealing element is injection molded onto the outer circumferential surface of the feed line.

6. The drive unit according to claim 2, wherein the sealing element is a bushing.

7. The drive unit according to claim 6, wherein the bushing is pressed into the inner circumferential surface of the bore.
